(19) United States
(12) Patent Application Publication
(10) Pub. No.: US 2023/0045055 A1
(43) Pub. Date: Feb. 9, 2023

(54) INFORMATION INPUT SYSTEM

(71) Applicant: TOYOTA JIDOSHA KABUSHIKI KAISHA, Aichi-ken (JP)

(72) Inventors: Shoji ITOH, Nagoya-shi, Aichi-ken (JP); Satofumi KURISU, Nagoya-shi, Aichi-ken (JP)

(21) Appl. No.: 17/841,588

(22) Filed: Jun. 15, 2022

(30) Foreign Application Priority Data
Aug. 6, 2021 (JP) 2021-130274

(51) Int. Cl. G06F 9/451; G06F 3/0482; G06Q 10/02

(52) U.S. Cl. CPC G06F 9/451; G06F 3/0482; G06Q 10/02; G06F 3/167

(57) ABSTRACT

In a reception system, when a user is identified by a terminal device, a menu set in accordance with user information of the identified user is displayed on a display of the terminal device. This displays a user interface including a menu that is easy for the user to perform an input operation, whereby the user can easily perform the input operation for a vehicle dispatch reservation.

### CROSS-REFERENCE TO RELATED APPLICATION

This application claims priority to Japanese Patent Application No. 2021-130274 filed on Aug. 6, 2021, incorporated herein by reference in its entirety.

### BACKGROUND

### 1. Technical Field

The present disclosure relates to an information input system.

### 2. Description of Related Art

Japanese Unexamined Patent Application Publication No. 2021-009514 (JP 2021-009514 A) discloses a carpooling vehicle arrangement system. In the carpooling vehicle dispatch system, a user who desires carpooling registers a usage reservation in a vehicle dispatch server using a terminal. At this time, when the usage information such as a boarding point, a drop-off point, the number of users, and the arrival time at the drop-off point is input from the terminal and the usage reservation is registered, the vehicle dispatch server arranges a taxi for transporting the users from the boarding point to the destination based on the input usage information.

On the other hand, Japanese Unexamined Patent Application Publication No. 2005-210310 (JP 2005-210310 A) discloses a multifunction device provided with a radio frequency identification (RFID) control unit. In the multifunction device, the RFID control unit executes authentication by reading a user identification (ID) from a memory card in a non-contact manner using radio waves, and comparing the read user ID with the user ID registered in advance.

Further, the multifunction device reads a learning menu together with a registered customized menu for the authenticated user and displays the menus on a touch panel, whereby operability of the user is improved.

### SUMMARY

A terminal device that enables various reservations and the like is provided with a user interface for making reservations, and the user inputs various types of information for making a reservation using the user interface of the terminal device. It is desired that such a user interface is easy for any user to input and operate.

The present disclosure has been made in view of the above fact, and an object of the present disclosure is to provide an information input system in which a user can easily input information when the user inputs information such as various requests.

To achieve the above object, an information input system according to claim 1 includes: an input operation unit that receives an input of predetermined information from a user using a user interface that is set for receiving a request from the user when the user performs an input operation via the user interface; a reading unit that reads information for identifying the user; and a setting unit that sets the user interface adapted to the user by acquiring user information of the user using the information for identifying the user that is read by the reading unit, and setting the user interface in the input operation unit in accordance with the user information.

In the information input system according to claim 1, the reading unit reads the information for identifying the user, and the input operation unit receives the information input by the user when the user performs the input operation using the user interface set for receiving the information input by the user.

Here, the setting unit acquires the user information of the user using the information for identifying the user that is read by the reading unit, and sets the user interface adapted to the user in the input operation unit in accordance with the user information. With the above, setting the user information that facilitates the input operation by the user makes it possible for the user to easily perform the input operation of the information.

In the information input system according to claim 2, in claim 1, the user information includes physical characteristics of the user, and the setting unit sets the user interface in accordance with the physical characteristics of the user.

In the information input system according to claim 2, the user information includes the physical characteristics of the user. This sets the user interface that is easy to operate in accordance with the physical characteristics of the user. With the above, the input operation of the user is suppressed from being affected by the physical characteristics, whereby the user can effectively perform the input operation.

In the information input system according to claim 3, in claim 1 or 2, the user information includes visual acuity information of the user and auditory information of the user, and the setting unit includes setting of a font size in the user interface based on the visual acuity information, and setting of a voice guidance volume in the user interface based on the auditory information.

In the information input system according to claim 3, the user information includes the visual information of the user and the auditory information of the user, and the setting unit sets the font size in the user interface based on the visual information of the user, and sets the voice guidance volume in the user interface based on the auditory information. With the above, the font size can be enlarged for users with weak eyesight, and the voice guidance volume for operations in the user interface can be increased for users with weak hearing, whereby the user can smoothly perform the input operation regardless of physical characteristics.

In the information input system of claim 4, in any one of claims 1 to 3, the reading unit is provided in the input operation unit, and the input operation unit is installed in a facility used by a plurality of the users.

In the information input system according to claim 4, the reading unit is provided in the input operation unit, and the input operation unit is installed in the facility used by the users. Therefore, even when the user does not own a device capable of input operation, the user can perform the input operation at the facility used by the user and the location where the user performs the input operation can be identified, whereby the input operations for various requests can be effectively performed.

According to the information input system of the present disclosure, the user interface is set in accordance with the user information, thereby achieving a superior effect that the optimum user interface can be set for the user and the user can easily perform the input operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein.

FIG. 1 is a block diagram showing a schematic configuration of a reception system according to the present embodiment;

FIG. 2 is a functional block diagram of the reception system;

FIG. 3 is a schematic configuration diagram of a computer provided in the reception system;

FIG. 4A is a schematic diagram showing an example of the basic layout of a menu, and FIG. 4B is a schematic diagram showing a color wheel;

FIG. 5 is a schematic diagram showing an example of the menu;

FIGS. 6A and 6B are schematic diagrams showing an example of the menu for designating a departure time, respectively;

FIGS. 7A and 7B are schematic diagrams showing an example of the menu for designating a destination, respectively; and

FIG. 8 is a schematic diagram showing an example of a remote control switch used for input.

### DETAILED DESCRIPTION OF EMBODIMENTS

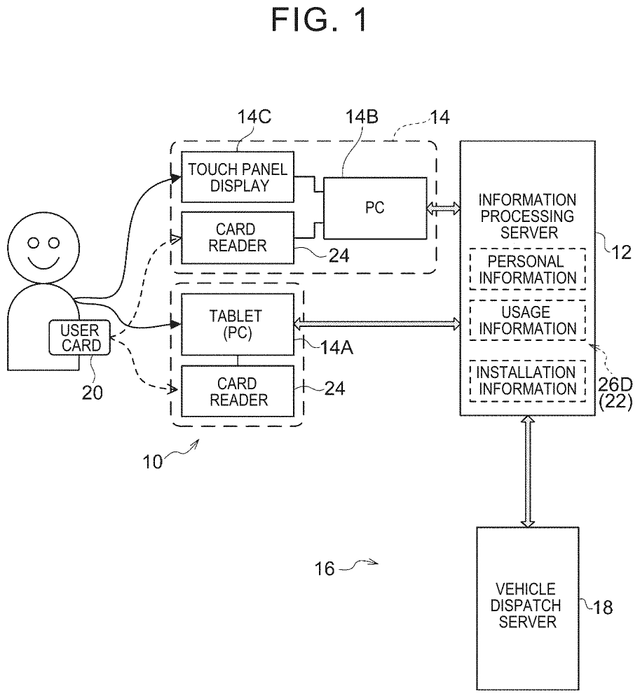

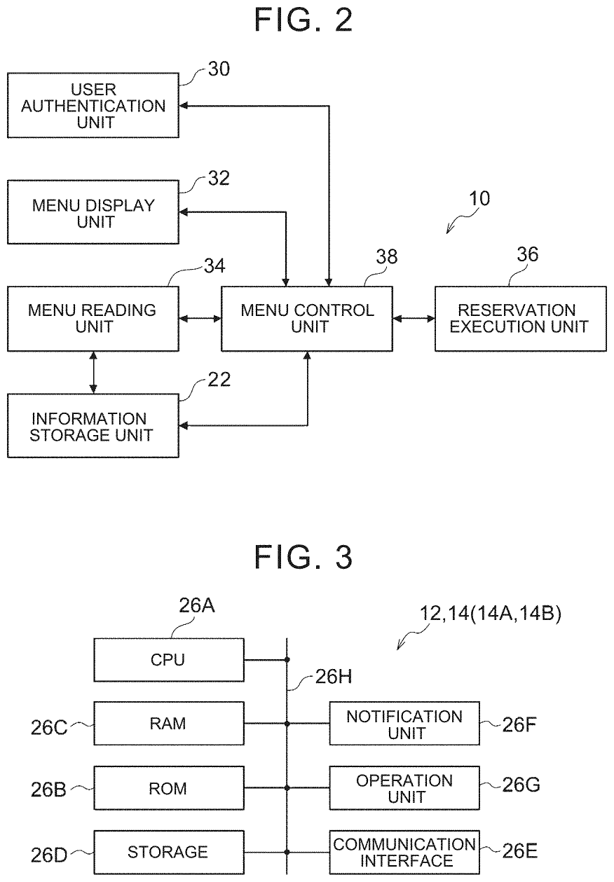

Hereinafter, an embodiment of the present disclosure will be described below with reference to the drawings. A reception system 10 as an information input system according to the present embodiment receives information input from a user and enables post-processing in accordance with the received information. FIG. 1 is a block diagram showing a schematic configuration of the reception system 10 to which the information input system according to the present embodiment is applied, and FIG. 2 is a functional block diagram showing a schematic configuration of the reception system 10. Further, FIG. 3 shows a schematic configuration diagram of a computer provided in the reception system 10.

As shown in FIG. 1, the reception system 10 includes an information processing server 12 and a plurality of terminal devices 14 as client terminals, and is configured as a client server system by the information processing server 12 and the terminal devices 14. The terminal devices 14 are respectively installed at multiple predetermined installation locations such as various facilities used by an unspecified number of people including a plurality of users, and each of the terminal devices 14 can be operated by the users.

In the present embodiment, the reception system 10 is connected to a vehicle dispatch system 16. The information processing server 12 of the reception system 10 is connected to each of the terminal devices 14 and connected to a vehicle dispatch server 18 of the vehicle dispatch system 16 using standards such as the Ethernet (registered trademark), fiber distributed data interface (FDDI), Wi-Fi (registered trademark), etc.

In the reception system 10, the information processing server 12 receives vehicle dispatch information as the user inputs information on a vehicle dispatch request as information to be input by the user from each of the terminal devices 14 to the vehicle dispatch system 16. That is, the information processing server 12 receives information on a vehicle dispatch reservation (hereinafter referred to as a vehicle dispatch reservation) of the user as the user inputs, via each terminal device 14, information on arrangement of the vehicle (vehicle dispatch request) for the user to move (go out). Further, the vehicle dispatch server 18 arranges a vehicle for the user to move based on the vehicle dispatch reservation received by the information processing server 12. With the above, the reception system 10 functions as a vehicle dispatch reception system. In the present embodiment, the information processing server 12 and the vehicle dispatch server 18 are provided. However, a single server may operate as the functions of the information processing server 12 and the vehicle dispatch server 18.

The reception system 10 can be used by the users who are registered in advance (pre-registered users). In the reception system 10, a user card (individual card) 20 dedicated for each of the pre-registered users is allotted to each pre-registered user, and the user can use the terminal devices 14 provided in various facilities, etc. using the user card 20.

Personal information for identifying the registered user is assigned to (supported by) the user card 20. The personal information includes an identification code assigned to each user card 20 as information for identifying the user card 20 or a personal code assigned to each user registered in the user card 20 as information for identifying the user.

In addition, the personal information includes authentication information for performing biometric authentication of the user. Fingerprint authentication, iris authentication, face authentication, etc. can be applied to biometric authentication. For example, when face authentication is applied, characteristics information (face authentication information) extracted from the face of the user is applied as the authentication information.

As the user card 20 including the personal information, an integrated circuit (IC) card in which the personal information is stored in an IC chip, a card in which the personal information is written in a two-dimensional bar code, and the like can be applied. Further, the terminal device 14 includes a card reader 24 as a reading unit for reading the personal information from the user card 20. When the IC card is used as the user card 20, an IC card reader or the like is used as the card reader 24. Further, when the user card 20 in which the personal information is written in a two-dimensional bar code is used, a bar code reader provided with a camera or the like for capturing a two-dimensional bar code is used as the card reader 24.

It is preferable that the user card 20 can read the personal information in a non-contact manner. On the basis of the above, the user card 20 in which the personal information is recorded in a two-dimensional bar code is used as the user card 20, and the terminal device 14 includes the card reader 24 that functions as a bar code reader. In the reception system 10, a plurality of formats (types) may be applied as a supporting format of the personal information in the user card 20, and in this case, the card reader 24 that fits each of the supporting formats of the personal information in the user card 20 is installed in the terminal device 14.

On the other hand, the information processing server 12 is provided with an information storage unit 22, and the information storage unit 22 stores user information for each user. The user information for each user is stored in the information storage unit 22 in association with the identification code of the user card 20 carried by the user or the personal code of the user.

The user information includes general information on the user such as age, gender, place of residence (address), family structure, etc. of the user. Further, in the reception system 10, physical information on the physical characteristics of the user is included as the user information. The physical information of the user includes visual information such as the presence or absence of abnormalities in the color vision function and visual acuity, and auditory information such as hearing ability and audible frequency range. In addition, the physical information of the user can include information on the motor function of the user, and the information on the motor function includes walking function information on, for example, whether the user is using a wheelchair or the user uses a stick while walking.

Further, the user information includes usage information of the reception system 10 and the vehicle dispatch system 16 for the user. The usage information includes a vehicle dispatch history (reservation history) of the user who uses the reception system 10. The vehicle dispatch history includes the date and time of use and the location of use (departure point, destination, waypoint) of the user such that the purpose of the user (going to hospital, shopping, sightseeing or the like) and a frequency of the vehicle dispatch reservations and a time slot for each of the purposes can be identified based on the vehicle dispatch history.

Further, in the reception system 10 used for the vehicle dispatch system 16, the terminal devices 14 are installed in various facilities used by residents and the like in an area covered by the vehicle dispatch system 16. As the facility where the terminal device 14 is installed, public facilities such as administrative institutions and libraries, commercial facilities such as shopping malls and shopping districts, medical facilities such as hospitals, tourist facilities such as parks, and the like can be applied. The information storage unit 22 of the information processing server 12 stores installation information for identifying an address or the like indicating the installation location of each terminal device 14.

As the vehicle dispatch system 16, various configurations for distributing the vehicle in accordance with a request of the user can be applied. For example, the vehicle dispatch system 16 may cause a vehicle such as a bus (the vehicle may also be a wagon) to circulate at a predetermined time or at predetermined time intervals within a preset area, and cause the circulating vehicle to move to the departure point at the departure time designated by the user and travel to the destination.

Further, a demand transportation service using public transportation can operate a vehicle (demand bus) by freely combining operation schedules and departure-arrival points, and the vehicle dispatch system 16 may be a demand transportation service using a demand bus. With the above, the installation locations of the terminal devices 14 of the reception system 10 are set as the departure-arrival points. The vehicle does not stop by at the departure-arrival point where there is not a request for boarding or drop-off (boarding or drop-off of the user is not scheduled), and the vehicle can stop by at only the departure-arrival point where there is a request for boarding or drop-off (boarding or drop-off of the user is scheduled), whereby an effective operation is possible.

On the other hand, as shown in FIG. 3, the information processing server 12 and the terminal devices 14 each include a central processing unit (CPU) 26A, a read-only memory (ROM) 26B, a random access memory (RAM) 26C, a storage 26D, a communication interface 26E, a notification unit 26F, and an operation unit 26G, and these constituent elements are connected so as to be communicate with each other (transmit and receive data and the like to and from each other) via a bus 26H. That is, a configuration including a microcomputer is applied to each of the information processing server 12 and the terminal devices 14, and a tablet 14A, a small personal computer (PC 14B), or the like is used as the terminal device 14.

The ROM 26B stores various programs and various data. The RAM 26C temporarily stores a program or data as a work area. The storage 26D can be composed of a hard disk drive (HDD) or a solid state drive (SSD), and stores various programs including an operating system and various data. The CPU 26A is a central processing unit that executes various programs and that controls various units.

With the above, the CPU 26A reads the program from the ROM 26B or the storage 26D and executes the program using the RAM 26C as a work area. The CPU 26A controls each configuration and executes various arithmetic processes in accordance with the program recorded in the ROM 26B or the storage 26D.

The communication interface 26E is an interface between the information processing server 12 and the terminal devices 14 or an interface for the information processing server 12 to communicate with the vehicle dispatch server 18, and a standard such as Ethernet (registered trademark), FDDI, Wi-Fi (registered trademark) or the like is used, for example.

The operation unit 26G includes functions of a pointing device such as a mouse, and a keyboard, and is used for performing various inputs. The notification unit 26F includes, for example, a liquid crystal display, and the display functions as a display unit that displays various types of information.

A touch panel method is adopted in the notification unit 26F in the tablet 14A of the terminal device 14, and functions as the operation unit 26G. Further, a touch panel type display 14C is used in the terminal device 14 for which the PC 14B is used, and the display 14C is connected to the PC 14B to constitute the display unit in the notification unit 26F and the operation unit 26G. Further, the notification unit 26F of the terminal device 14 is provided with a speaker (not shown) that emits voice or the like, whereby voice guidance in accordance with indications on the display is possible.

As shown in FIG. 2, the reception system 10 is provided with the information storage unit 22, a user authentication unit 30, a menu display unit 32 that functions as a user interface, a menu reading unit 34, a reservation execution unit 36, and a menu control unit 38. In the reception system 10, the CPU 26A of the information processing server 12 and the CPU 26A of the terminal device 14 operate in cooperation with each other such that each function of the user authentication unit 30, the menu display unit 32, the menu reading unit 34, the reservation execution unit 36, the menu control unit 38 is realized. Further, the information storage unit 22 is realized by the storage 26D of the information processing server 12.

The user authentication unit 30 is realized using the card reader 24 provided in the terminal device 14 and a face authentication camera (not shown). The user authentication unit 30 reads the personal information including the authentication information from the user card 20 as the user holds the user card 20 over the card reader 24. Further, the user authentication unit 30 captures a face image of the user by a face recognition camera and compares the captured face image with the authentication information. With the above, two-factor authentication is performed for confirming whether the user who operates the terminal device 14 and the user registered for the user card 20 are the same.

In the reception system 10, when the terminal device 14 accepts the operation of the user, a menu (menu screen) constituting the user interface is displayed on the display of the terminal device 14. In the reception system 10, the menu is customized for each user and stored in the information storage unit 22.

The menu reading unit 34 reads the menu corresponding to the user authenticated on the terminal device 14 from the information storage unit 22. The menu display unit 32 displays the menu read from the information storage unit 22 on the display of the terminal device 14. This enables the user to operate the terminal device 14 for making a vehicle dispatch reservation.

The menu control unit 38 controls the menu reading unit 34 and the menu display unit 32 based on the authentication result of the user authentication unit 30. Further, the menu control unit 38 controls reading of the menu in the menu reading unit 34 in response to the operation of the menu display unit 32 by the user, and controls display of the menu of the menu display unit 32. Further, the menu control unit 38 controls the reservation execution unit 36 based on the operation of the user on the menu displayed on the menu display unit 32, receives the vehicle dispatch reservation from the user, and outputs the received vehicle dispatch reservation to the vehicle dispatch server 18.

On the other hand, the menu control unit 38 sets (creates) a menu that constitutes the user interface customized for each user, based on the user information for each user stored in the information storage unit 22. Further, the menu control unit 38 acquires a usage history that records use of the reception system 10 (vehicle dispatch system 16) by the user, and updates the menu set for each user based on the acquired usage history.

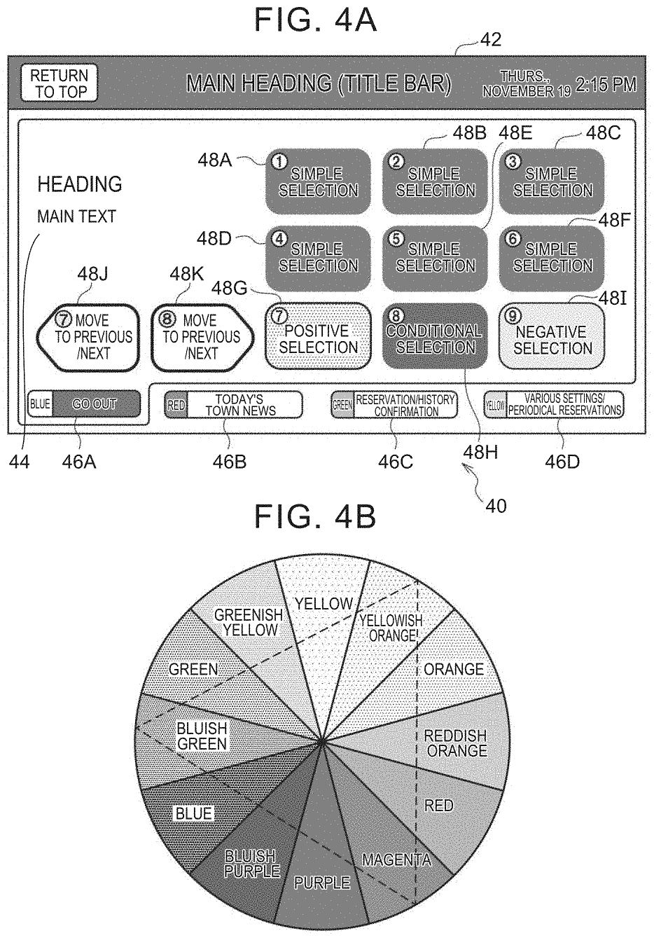

Hereinafter, as the operation of the present embodiment, setting of the user interface such as the menu for each user and a reception process of the vehicle dispatch reservation using the set user interface will be described. FIG. 4A shows a schematic diagram of the basic layout of the menus displayed on the display of the terminal device 14 and constituting the user interface, and FIG. 4B shows a schematic diagram of a color wheel.

As shown in FIG. 4A, a menu 40 (menu screen) of the basic layout has a predetermined background color (for example, white), and a title bar 42 that is the main heading of the menu 40 is arranged in an upper portion of the screen. A heading area 44 is provided on the lower left side of the title bar 42, and a heading and a description thereof are written in the heading area 44. The heading area 44 can be enlarged and reduced in accordance with the display contents, and the display of buttons 48A to 48I below is partially or entirely omitted as the heading area 44 is enlarged.

Further, images (buttons 46A, 46B, 46C, 46D) of multiple buttons as defined selection target elements are arranged side by side in a lower portion of the screen of the menu 40. The blue button 46A labeled “Go out” is the selection button for the menu for going out, and the red button 46B labeled “Today's town news” is the selection button for displaying events in the area. Further, the green button 46C displayed as “Reservation/history confirmation” is used as a selection button for a confirmation menu of a reservation (vehicle dispatch reservation) and the history of the user, and the yellow button 46D displayed as “Various settings/periodical reservations” is used as a selection button for various settings for the user and a menu for going out with periodical reservations.

Further, in the menu 40, images of the buttons (buttons 48A, 48B, 48C, 48D, 48E, 48F, 48G, 48H, 48I) as selection target elements are arranged in the area from the center to the right side below the title bar 42 and arranged vertically and horizontally (in three vertical columns and three horizontal rows). A button number is assigned to each of the buttons 48A to 48I, and characters indicating the outline of the contents to be selected are also written along with the button number.

Here, in the reception system 10, the buttons 48A to 48F in the upper and middle rows are set to the contents to be selected (options for the users). Further, in the reception system 10, the 48G to 48I in the lower row are used for switching the display order of the options (selection contents) indicated by the buttons 48A to 48F. For example, the button 48G is set for switching the displayed options (including the non-displayed options) to the positive option order, the button 48H is set for switching the display options to the negative option order, and the button 48I is set for switching the display options to the conditional option order.

Further, in the menu 40, images of the buttons (buttons 483, 48K) as selection target elements are arranged below the heading area 44, and the characters indicating the button numbers and the outlines of the contents to be selected are assigned (added) to the buttons 48J, 48K. The buttons 48J, 48K are used for moving to other menus, for example, and the shapes are designed such that the moving direction can be intuitively recognized. The button 48J is used for moving to the previous side and the button 48K is used for moving to the next side.

The menu control unit 38 arranges the selection target elements based on the basic layout (the layout of the menu 40), and sets the options for each selection target element. At this time, the menu control unit 38 sets options for each selection target element based on the user information and usage history of each user, and sets options for multiple layers (for example, five layers at the maximum) such that the options can be refined for each set selection target element. With the above, the menu control unit 38 sets a user interface (menu) for each user such that information desired by the user (information on the vehicle dispatch reservation) can be input by multiple selection operations by the user.

At this time, in the menu control unit 38, when the number of options is smaller than the number of the buttons 48A to 48F, the buttons are not arranged to closer to the buttons with higher numbers. For example, a button corresponding to a positive option and a button corresponding to a negative option are set to be arranged with a space therebetween (a hidden button is provided). With the above, the user can intuitively grasp the position of the button of the positive option and the position of the button of the negative option.

Further, in the color wheel shown in FIG. 4B, for example, a color scheme that forms a triangle such as between “yellowish orange”, “bluish green”, and “magenta” can improve the color balance. On the basis of the above, the menu control unit 38 can make the user to have an image of whether the content of the option is positive or negative depending on the color of the image indicating the selection target element. For example, warm colors tend to give positive images with positive feelings, and gray colors give negative images such as being invalid or impossible.

On the basis of the above, in the reception system 10, a basic color (image color) that serves as the base is set, each color from the warm color system, the gray color system, and the neutral color system is set such that a triangle (shown by a broken line in FIG. 4B) is formed in the color wheel based on the set basic color, and other colors are set such that the brightness and saturation of each color do not become too strong. With the above, in the reception system 10, a color scheme that gives warmth as a whole is applied while expressing the difference in buttons by the difference in color.

Further, in the menu control unit 38, the button indicating a positive option (image of the selection target element) is set to a warm color, and the button indicating a negative option is set to a gray color. Further, the menu control unit 38 sets a neutral color for an option between a positive option and a negative option (for example, an option with conditional contents). This enables the user to intuitively grasp the content of the option from the color of the button indicating the option.

Further, the menu control unit 38 sets a menu for each user based on the usage history accumulated for each user. With the above, when the user makes a vehicle dispatch reservation, it is possible to select a desired vehicle dispatch reservation with a small number of selection operations.

On the other hand, in the reception system 10, the physical information indicating the physical characteristics of the user as the user information is registered. The menu control unit 38 uses the physical information of the user when setting the user interface for each user. The physical information includes visual information such as visual acuity, and the font size (character size) of the characters displayed on the menu is enlarged for users with weak eyesight than the users without weak eyesight.

In addition, the visual information may include information indicating that a specific color is difficult to see (so-called color blindness). When the menu control unit 38 includes information indicating that a specific color is difficult to see in the visual information, the color scheme is changed to the color scheme not including the color that the user is difficult to see while the color scheme including the color that the user is difficult to see is not applied, and the color of each button (selection target element) to be used in the menu is set.

In addition, the physical information includes auditory information such as hearing. For users with weak hearing (difficult to hear sound), the volume is set to be high when voice guidance is provided.

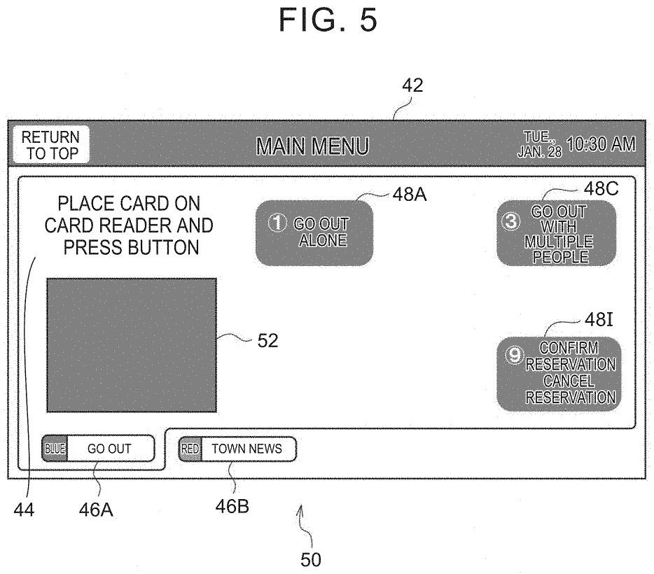

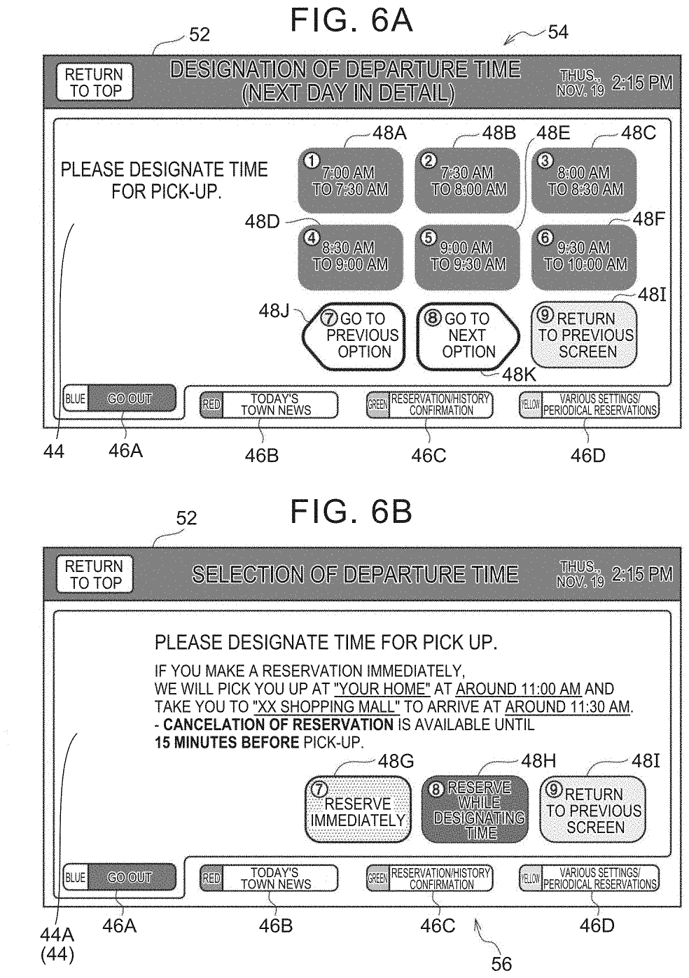

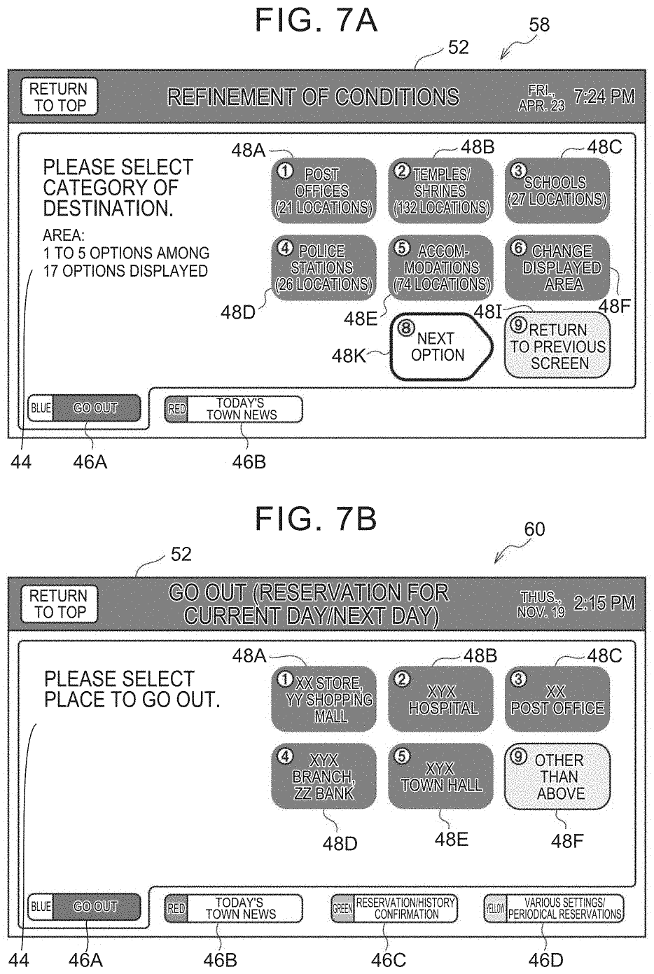

Next, a specific example of the menu (user interface) displayed on the terminal device 14 for the vehicle dispatch reservation of the user will be described. FIG. 5 is a schematic diagram showing an example of a menu. Further, FIGS. 6A and 6B are schematic diagrams each showing an example of the menu for designating the departure time, and FIGS. 7A and 7B are schematic diagrams showing an example of the menu for designating the destination.

A menu 50 shown in FIG. 5 is displayed as the user operates the button 46A on an initial screen (not shown) of the terminal device 14. In the menu 50, the buttons 48A, 48C, and 48I are displayed, and the operation guide is displayed in the heading area 44. Further, in the menu 50, an image (or video (not shown)) instructing the user to hold the two-dimensional bar code of the user card 20 over the camera of the card reader 24 is displayed in an image area 52 below the heading area 44.

When the menu 50 is displayed, the menu control unit 38 reads the personal information from the user card 20, and executes an authentication process on whether the characteristics information acquired by capturing an image of the face of the user matches the face authentication information included in the personal information. The reception system 10 executes two-factor authentication using the authentication information recorded on the user card 20 and the characteristics information acquired from the user who operates the terminal device 14. Therefore, it is possible to suppress the user card 20 from being used by anyone other than the user who is registered in the user card 20.

The menu control unit 38 causes the terminal device 14 to display the menu 50 set for the authenticated user. Therefore, when the font size is set to be larger based on the physical information of the user, the font size of the characters in each menu including the menu 50 is changed. This makes it possible to suppress the user with weak eyesight from feeing that the characters such as those in the menu 50 displayed on the display are hard to see or unable to see, which results in causing stress. Moreover, since the characters are easy to see, the user can smoothly make a vehicle dispatch reservation.

Further, when the menu control unit 38 is set to increase the volume of voice of the voice guidance based on the physical information of the user, the volume of the voice guidance in each menu including the main menu (the menu 50, etc.) is changed to increase. With the above, it is possible to suppress the user with weak hearing from being stressed because the user has a difficulty to listen to the voice guidance emitted from the terminal device 14.

When the button 48C is operated in the menu 50, the authentication process for one user is completed, and the authentication process for the other users is executed and then the vehicle dispatch reservation is made. Further, the vehicle dispatch reservation of the authenticated user may be made, and then the vehicle dispatch process of another user may be executed.

Note that, when the button 48I is operated, a menu for making a confirmation and cancellation for the authenticated user (not shown) is displayed, and the confirmation and cancellation process of the existing vehicle dispatch reservation (reservation before the vehicle is dispatched) can be executed. At this time, when the confirmation and cancellation of reservations of the multiple users are performed, the reservation confirmation and cancellation process is executed for each user.

Further, when the button 48A is operated, the next menu for the vehicle dispatch reservation is displayed. In the vehicle dispatch reservation, since the user is authenticated and the departure point is set to the installation location of the terminal device 14, the departure time of the user, destination, etc. are input.

FIG. 6A shows a menu 54 for setting the departure time with the departure time as the next day. In the menu 54, options for the departure time (time slot) are displayed in chronological order on each of the buttons 48A to 48F. This allows the user to easily select and set the departure time. Note that, in the menu 54, the buttons 48J, 48K are displayed instead of the buttons 48G, 48H, respectively.

Further, FIG. 6B shows a menu 56 for setting the departure time with the departure time as the current day. The buttons 48G, 48H, 48I are displayed in the menu 56, and the departure time, the destination, the arrival time at the destination and the like w % ben the button 48G is operated are explicitly displayed in a heading area 44A that is extended instead of the heading area 44. Note that, in the menu 56, a menu for selecting the departure time at or after the current time is displayed (for example, a menu corresponding to FIG. 6A) when the user operates the button 48H.

FIG. 7A shows a menu 58 for selecting the destination from the destination options set in the vehicle dispatch system 16 as an example of the conditional menu. In the menu 58, the selectable destinations are classified into categories, and a specific destination can be selected from the categories. The categories can be selected when the user presses the buttons 48A to 48E.

In the menu 58, the number of categories is shown in the heading area 44, and the button 48F is used for selecting the destination of another category (other than the categories that can be selected by the buttons 48A to 48E).

Further, FIG. 7B shows a menu 60 for selecting a destination set based on the usage history of the user as an example of a conditional menu. The menu 60 can be applied to, for example, selection of the destination on the current day or the next day, and the buttons 48A to 48E are, for example, selected as destinations set in descending order of frequency of use by the user.

When there is a destination preset by the user as the destination to be displayed in the menu 60, the menu control unit 38 sets the destination preset by the user to a button with a small number (for example, the button 48A).

In addition, when the user makes a vehicle dispatch reservation, such as when the user visits a hospital, the medical treatment time is often reserved. In this case, the reception system 10 acquires the medical treatment date and time reserved at the medical institution to be visited and stores the date and time as the user information. With the above, when the user makes a vehicle dispatch reservation, the user can select the corresponding medical institution as the destination with the highest priority while it is explicitly indicated that the medical treatment reservation is made in the case where the time is a time corresponding to the medical treatment date and time that is reserved. With the above, it is possible to suppress the user from being unable to meet the medical treatment time reserved by the user.

As described above, in the reception system 10, the menu control unit 38 identifies the user from the personal information read from the user card 20 by the card reader 24, and sets a menu adapted to the user using the user information of the identified user. With the above, setting the user information that facilitates the input operation by the user makes it possible for the user to easily perform the input operation for the vehicle dispatch reservation.

Further, in the reception system 10, the user information includes the physical characteristics of the user, and the menu control unit 38 sets the menu in accordance with the physical characteristics of the user. With the above, a menu that can suppress the input operation of the user from being affected by the physical characteristics is set, whereby the user can effectively perform the input operation.

Further, the reception system 10 sets the font size in the menu (user interface) based on the visual information included in the user information, and sets the voice for the voice guidance for the menu based on the auditory information included in the user information. With the above, the user can smoothly perform the input operation even when the user have weak eyesight or weak hearing.

Further, in the reception system 10, the terminal devices 14 that are each provided with the card reader 24 and the display are installed in facilities used by an unspecified number of people. Therefore, the user can make a vehicle dispatch reservation with the vehicle dispatch system 16 at the facility where the user uses even when the user does not carry a mobile terminal that can access the vehicle dispatch system, such as a smartphone. Moreover, since the location (departure point) where the user is located is identified by the terminal device 14 to be used, it is not necessary to input the departure point for vehicle dispatch, and thus the input operation can be efficiently performed.

In the present embodiment, the departure point of the user is set as the installation location of the terminal device 14. However, the departure point and the destination may be the address of the user or the like. The address of the user can be acquired from the user information of the user, and when the address of the user is the departure place or the destination, the address of the user may be set using the menu for selecting the departure point (not shown).

On the other hand, in the present embodiment, the terminal devices 14 are installed in facilities used by a large number of users, and the installation location of the terminal device 14 is set as a departure point or a destination. However, a mode in which the terminal device (input operation unit and reading unit) is installed in the house of the user may be adopted.

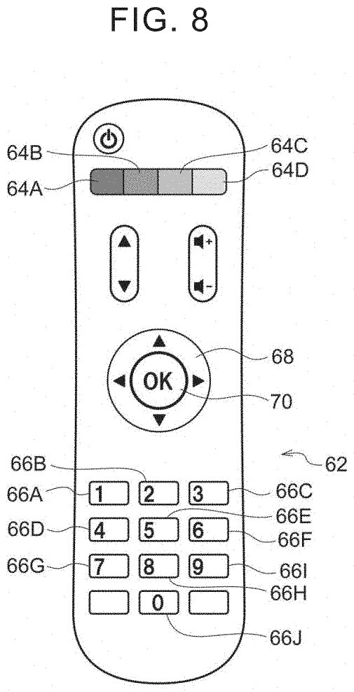

In this case, a television installed in the house of the user may be connected to the information processing server (setting unit), and used as a display unit for making a display corresponding to the user interface. Further, a remote controller (remote control switch) of the television can be used as an operation unit in the user interface. FIG. 8 is a schematic diagram showing a remote control switch 62 used as an operation unit in the user interface having the television as the display unit.

As shown in FIG. 8, the remote control switch 62 is provided with a button 64A, a button 64B, a button 64C, and a button 64D, and is provided with numerical buttons (buttons) 66A to 66J for channel selection. Further, the remote control switch 62 is provided with a cursor button 68 for selecting up and down and right and left and an enter button 70.

Here, the buttons 46A to 46D in the menu 50 and the like are made to correspond to the buttons 64A to 64D of the remote control switch 62, and the operations of the buttons 64A to 64D are caused to function in the same manner as the operations of the buttons 46A to 46D in the menu 50 and the like.

Further, the buttons 66A to 66I (excluding the button 66J) of the remote control switch 62 are made to correspond to the buttons 48A to 48I to which the button numbers in the menu 50 and the like corresponding to the channel numbers are assigned. When the buttons 66A to the buttons 66I of the remote control switch 62 are operated, the operations of the buttons 66A to 66I are caused to function in the same manner as the operations of the buttons 48A to 48I in the menu 50 and the like. Further, the configuration may be set such that the selection target element can be selected in the menu 50 and the like when the cursor button 68 and the enter button 70 of the remote control switch 62 are operated.

Further, in the operation using the remote control switch 62, the selected selection target elements (the buttons 46A to 46D, 48A to 48I in the menu 50 and the like) can be explicitly indicated in a manner such that the outer shape of the selected selection target element is changed from a rectangular to a circular shape (the outer shape may be chamfered) or the selected selection target element is rendered with a shadow from a state of no shadow.

With the above, the user can make a vehicle dispatch reservation using the television owned by the user or a family of the user. Further, the home of the user can be selected as the departure point when the user makes a vehicle dispatch reservation. Therefore, it is not necessary to set the departure point as in the case of using the terminal device 14. Moreover, the user can be authenticated in advance, whereby the process for the vehicle dispatch reservation can be simplified.

Further, when the television installed in the house of the user and the remote control switch 62 are used, a function (family function) that can be set for each family may be provided. In this case, a list of family members registered in advance may be displayed on the television, and a user who actually makes a vehicle dispatch reservation may be selected from the displayed list. With the above, registration of user information for each family member in advance makes it possible to use the user interface such as a menu customized for the user who performs the input operation.

Further, in the present embodiment, hearing and visual acuity have been described as examples of the physical characteristics. However, in the case of visual impairment, the user cannot see the menu itself even when the font size is increased. When the visual information includes visual impairment, a voice input interface may be provided in the user interface, and the voice of the user may be used instead of the operation for the selection target element.

In this case, the user interface notifies the user of the menu and the contents of each option in the menu together with the button number by voice guidance, and detects the pronounced button number when the user pronounces the button number of the option selected by the user. After that, a determination may be made that the option corresponding to the detected button number is selected, and a process in accordance with the option determined to be selected may be executed.

Further, in the reception system 10 according to the present embodiment, the vehicle dispatch system 16 is connected to receive the vehicle dispatch reservation. However, the information input system may be connected to a service system (information processing system) that performs various services, and may have a function of receiving information input by the user to each of the various service systems, such as a request of the user.

Further, in the present embodiment, various functions are realized as the CPU reads and executes software (program). However, various processors other than the CPU may execute programs for realizing various functions. Exemplified as a processor in this case are a programmable logic device (PLD) such as a field-programmable gate array (FPGA) or the like in which a circuit configuration can be changed after manufacturing, and a dedicated electric circuit or the like that is a processor having a circuit configuration specially designed to execute a specific process such as an application specific integrated circuit (ASIC). Further, the program may be executed by one of these various processors, or in a combination of two or more processors of the same type or different types (for example, a combination of FPGAs, a combination of a CPU and an FPGA, and the like). Further, the hardware structure of each of the various processors may be an electric circuit in which circuit elements such as semiconductor elements are combined.

Further, in the above embodiment, the mode in which the predetermined program is stored (installed) in the ROM or the storage in advance has been described, but the present disclosure is not limited to this. The program may be provided in a form recorded on a recording medium such as a compact disk read-only memory (CD-ROM), a digital versatile disk read-only memory (DVD-ROM), and a universal serial bus (USB) memory. Further, the program may be downloaded from an external device via a network.

What is claimed is:

1. An information input system comprising:
an input operation unit that receives an input of predetermined information from a user using a user interface that is set for receiving a request from the user when the user performs an input operation via the user interface;
a reading unit that reads information for identifying the user; and
a setting unit that sets the user interface adapted to the user by acquiring user information of the user using the information for identifying the user that is read by the reading unit, and setting the user interface in the input operation unit in accordance with the user information.

2. The information input system according to claim 1, wherein:
the user information includes physical characteristics of the user; and
the setting unit sets the user interface in accordance with the physical characteristics of the user.

3. The information input system according to claim 1, wherein:
the user information includes visual acuity information of the user and auditory information of the user; and
the setting unit includes setting of a font size in the user interface based on the visual acuity information, and setting of a voice guidance volume in the user interface based on the auditory information.

4. The information input system according to claim 1, wherein:
the reading unit is provided in the input operation unit; and
the input operation unit is installed in a facility used by a plurality of the users.
